(19) United States
(12) Patent Application Publication
(10) Pub. No.: US 2020/0029066 A1
(43) Pub. Date: Jan. 23, 2020

(54) SYSTEMS AND METHODS FOR THREE-DIMENSIONAL LIVE STREAMING

(71) Applicant: Chengdu CK Technology CO., LTD., Chengdu (CN)

(72) Inventor: Song Jiao, Chengdu (CN)

(21) Appl. No.: 16/465,843

(22) PCT Filed: Dec. 29, 2017
(86) PCT No.: PCT/CN2017/120089

§ 371 Date: May 31, 2019

(30) Foreign Application Priority Data
Dec. 30, 2016 (CN) 201611258705.9

(51) Int. Cl. H04N 13/296; H04N 13/239; H04N 21/2187; H04N 13/194; H04N 13/271

(52) U.S. Cl. CPC H04N 13/296; H04N 13/239; H04N 13/271; H04N 13/194; H04N 21/2187

(57) ABSTRACT

The present disclosure relates to methods and associated systems for live streaming three-dimensional images based on images collected by two image collection devices. The method includes (1) receiving a first live stream from a first image collection device positioned toward an object at a first view angle; (2) receiving a second live stream from a second image collection device positioned toward the object at a second view angle; (3) determining a distance between the first image collection device and the second image collection device; (4) determining a view difference by analyzing pixels of the first image and the second image; and (5) generating a three-dimensional live stream of the object based on the first and second live streams, the determined view difference, and the distance between the first image collection device and the second image collection device.

### CROSS-REFERENCE TO RELATED APPLICATIONS

This application claims the benefit of Chinese Patent Application No. 2016112587059, filed Dec. 30, 2016 and entitled “A METHOD AND SYSTEM FOR LIVE STREAMING 3D VIDEOS,” the content of which is hereby incorporated by reference in its entirety.

### BACKGROUND

It has become more and more popular to live broadcast videos collected by a mobile device with a camera. However, viewers' expectation of image quality has also become higher and higher. Traditionally, live streaming provides viewers two-dimensional images. Sometimes it could be inconvenient or challenging for viewers who want to have views from different angles. Therefore, it is advantageous to address such a need by having an improved method or system for live streaming.

### BRIEF DESCRIPTION OF THE DRAWINGS

Embodiments of the disclosed technology will be described and explained through the use of the accompanying drawings.

FIG. 1A is a schematic diagram illustrating a system in accordance with embodiments of the disclosed technology.

FIG. 1B is a schematic diagram illustrating a view difference in accordance with embodiments of the disclosed technology.

FIG. 1C is a schematic diagram illustrating a system in accordance with embodiments of the disclosed technology.

FIG. 2 is a schematic diagram illustrating a system in accordance with embodiments of the disclosed technology.

FIG. 3 is a schematic diagram illustrating a live-stream device in accordance with embodiments of the disclosed technology.

FIG. 4 is a schematic diagram illustrating a live-stream device in accordance with embodiments of the disclosed technology.

FIG. 5 is a flowchart illustrating a method in accordance with embodiments of the disclosed technology.

FIG. 6 is a flowchart illustrating a method in accordance with embodiments of the disclosed technology.

The drawings are not necessarily drawn to scale. For example, the dimensions of some of the elements in the figures may be expanded or reduced to help improve the understanding of various embodiments. Similarly, some components and/or operations may be separated into different blocks or combined into a single block for the purposes of discussion of some of the embodiments. Moreover, although specific embodiments have been shown by way of example in the drawings and described in detail below, one skilled in the art will recognize that modifications, equivalents, and alternatives will fall within the scope of the appended claims.

### DETAILED DESCRIPTION

In this description, references to “some embodiment,” “one embodiment,” or the like, mean that the particular feature, function, structure or characteristic being described is included in at least one embodiment of the disclosed technology. Occurrences of such phrases in this specification do not necessarily all refer to the same embodiment. On the other hand, the embodiments referred to are not necessarily mutually exclusive.

The present disclosure relates to methods for live streaming a three-dimensional video based on images collected by two or more image collection devices (e.g., a sports camera). The disclosed system is configured to analyze/edit/combine the images collected by the two image collection devices and then generate a set of three-dimensional images for live streaming. For example, the disclosed system enables a system operator to use two sports cameras to collect images and then generate three-dimensional images for live streaming. The generated three-dimensional images can enhance viewer experience and accordingly improve viewer satisfaction. The disclosed system is capable of providing three-dimensional live streaming in a convenient, efficient fashion.

The disclosed system includes a server and two image collection devices configured to collect images. The two image collection devices are positioned to collect images of an object (e.g., pointing toward the object). In some embodiments, the two image collection devices can be coupled by a chassis, a structure, or a connecting device such that the distance between the two image collection devices remains unchanged when the two devices are collecting images.

To provide the disclosed system with suitable images to process, in some embodiments, the two image collection devices are configured to have similar angles of view toward an object. By so doing, the object can be shown in the same relative location (e.g., the center, a corner, etc.) of the collected images. For example, the object is shown in the center of the collected image. In some embodiments, the disclosed system enables an operator to set up the angles of view (e.g., by adjusting a zoom-in or zoom-out function of a camera) of the two images collection devices such that the object shown in the images collected by both devices occupies a similar or generally-the-same percentage of area of the images. Adjusting the angles of view of the two image collection devices helps position the object at particular location (and adjust their sizes) in the collected image. For example, the object is shown in the collected image and occupiers about 50% of the whole image. By this arrangement, the disclosed system can identify the image portions of the object and then perform a further analysis.

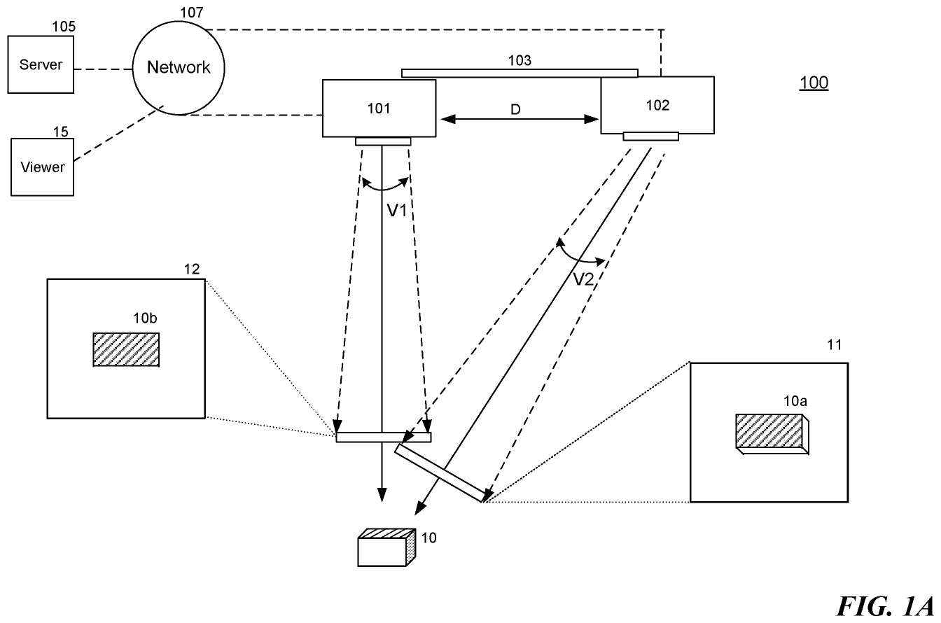

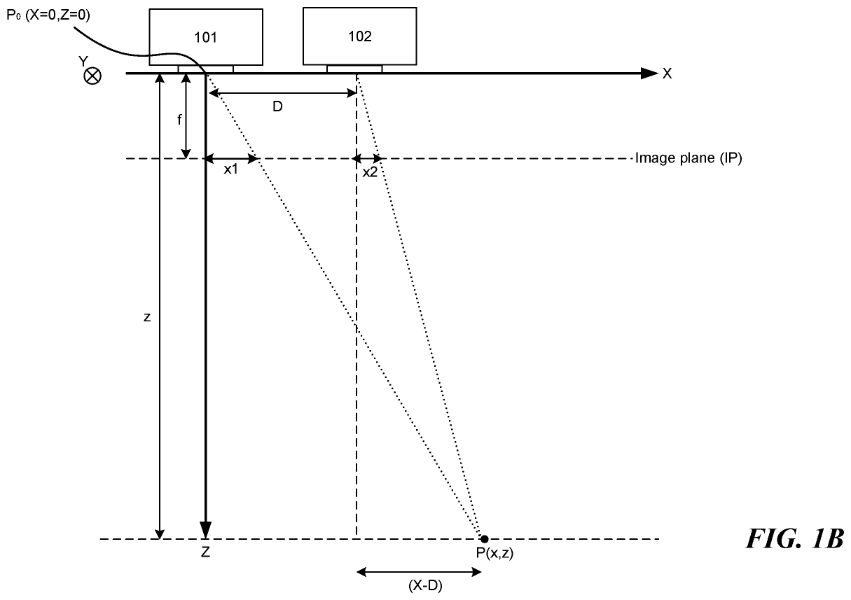

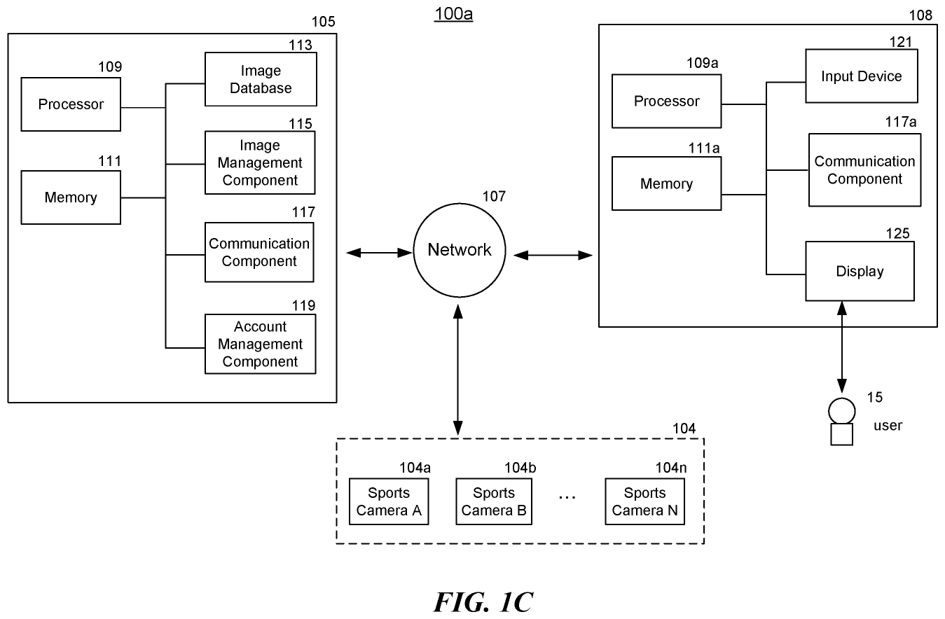

In some embodiments, the images are collected as live streams. The server receives a first live stream from one of the two image collection devices and a second live stream from the other image collection device. The server then combines the first and second live streams to generate a three-dimensional live stream, which can be viewed by a viewer in real-time through a network. The server generates the three-dimensional live stream based on the distance between the two image collection devices and a “view difference” (to be defined and discussed in detail with reference to FIG. 1B) determined by analyzing pixels of the first and second live streams. Wth the “view difference” and the distance between the two image collection devices, the disclosed system can determine “depth” information (e.g., the distance from the object to the first or second image collection device) of the first/second live streams and then can combine them accordingly to generate a three-dimensional live stream.

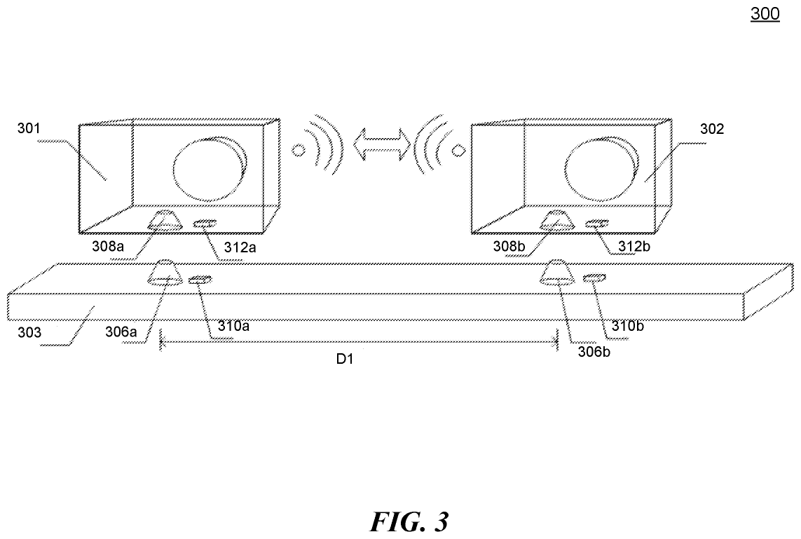

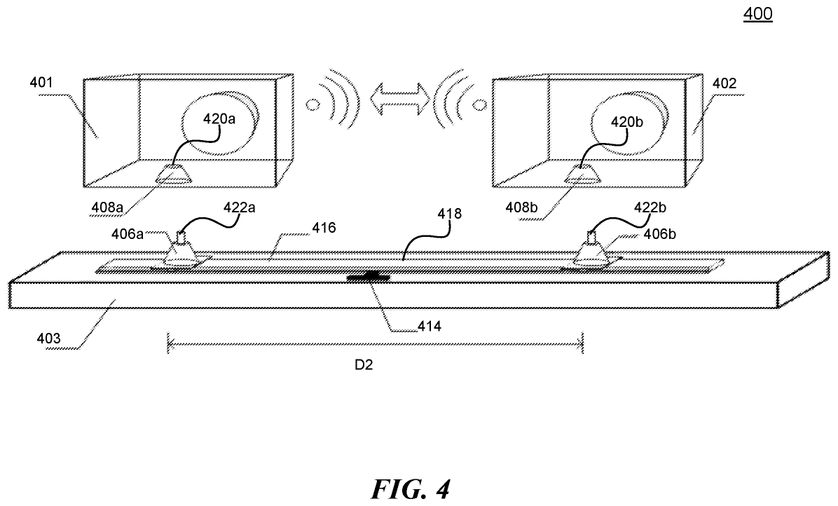

In some embodiments, the distance between the two image collection devices are known. In such embodiments, the two image collection devices can be positioned at predetermined locations of a structure or a chassis. The two image collection devices and the structure together can form a “live-stream device” which can cooperate with the server to generate a three-dimensional live stream (e.g., embodiments shown in FIGS. 3 and 4). In some embodiments, the disclosed system can include a sensor (e.g., a magnetic field sensor, a Hall-effect sensor, etc.) positioned in/on the chassis to determine whether the two image collection devices are positioned properly (e.g., FIG. 3). In some embodiments, the distance between the two image collection devices can vary and be measured dynamically (e.g., FIG. 4). For example, the disclosed system can include a sliding rail on the chassis for adjusting the relative locations of the two image collection devices (e.g., to adjust their angles of view). In such embodiments, the distance between the two image collection devices can be determined by measuring an electrical resistance of the sliding rail between the two image collection devices.

FIG. 1A is a schematic diagram illustrating a system 100 in accordance with embodiments of the disclosed technology. FIG. 1A provides an overview regarding the components of the disclosed system. As shown, the system 100 includes a first camera 101, a second camera 102, a chassis 103 configured to couple the first and second cameras 101, 102, and a server 105. As shown, the first camera 101 and the second camera 102 are positioned to collect images of a target object 10. The distance between the first camera 101 and the second camera 102 is distance D. The first camera 101 is positioned toward the target object 10 at a first view angle V₁ to collect a first image 11. The second camera 102 is positioned toward the target object 10 at a second view angle V₂ to collect a second image 12.

As shown, an object image 10a shown in the first image 11 is located at the center of the first image 11. The object image 10a occupies around 20% area of the first image 11. Similarly, an object image 10b shown in the second image 12 is also located at the center of the second image 12 and occupies generally the same percentage of area of the second image 12. The first camera 101 and the second camera 102 can upload the first and second images 11, 12 to the server 105 via a network 107. The server 105 can further analyze the first and second images 11, 12 (e.g., by analyzing pixels of the object images 10a and 10b to determine a view difference between the first and second images 11, 12, to be discussed below with reference to FIG. 1B). The server 105 then generates a three-dimensional live stream for a viewer 15 to download, view, stream, etc.

FIG. 1B is a schematic diagram illustrating a view difference of images collected by a first camera 101 and a second camera 102. The calculation/analysis is performed, in some embodiments, by a server (e.g., the server 105). Horizontal axis X and vertical axis Z (e.g., depth) are location reference axes. Axis Y represents another location reference axis that is not shown in FIG. 1B (e.g., perpendicular to a plane in which FIG. 1B is located). As shown, the first and second cameras 101, 102 are positioned on horizontal axis X, with distance D therebetween. Point P represents a pixel point of a target object, whose coordinates can be noted as (x, z). In some embodiments, the coordinates of point P can be noted as (x, y, z), in which “y” represents a coordinate in axis Y that is not shown in FIG. 1B. In the illustrated embodiment, point P₀ represents the original point of axes X and Z. Both the first and second cameras 101, 102 have a focal length f. In some embodiments, the focal length of the first and second cameras 101, 102 can be different.

The first and second cameras 101, 102 are configured to collect images of the target object at pixel point P (x, z). The images are formed on an image plane IP. As shown, the image collected by the first camera 101 (a first image) has length x1 on the image plane IP, and the image collected by the second camera 102 (a second image) has length x2 on the image plane IP. The “view difference” between the first and second images can be defined as (x1−x2). Based on equations (A)-(C) below, the point P (x, z) can be determined.

$$\begin{matrix}\frac{z}{f} = \frac{x}{x 1} = \frac{x - D}{x 2} & ( A ) \\ x = ( x 1 * z ) / f & ( B ) \\ z = ( f * D ) / ( x 1 - x 2 ) & ( C )\end{matrix}$$

The “z” value of point P represents its depth information. Once the depth information of every pixel point of the first and second images is known, the disclosed system can generate a three-dimensional image based on the first and second images (e.g., combine, overlap, edit, etc. the first and second images).

For example, the disclosed system can determine that at the image point P, the first image has a first depth Z₁ whereas the second image has a second image Z₂. The disclosed system can then generate a three-dimensional image based on the depth values Z₁, Z₂. For example, the disclosed system can overlap or combine the first and second images based on their depth values such that the combined image can provide a viewer with a three-dimensional viewer experience (e.g., the viewer sees the target point as a three-dimensional object).

In some embodiments, the first and second images can be two sets of live streams. In such embodiments, the generated three-dimensional image can also be a live stream. In some embodiments, the disclosed system can process the combined images based on various image-processing methods, such as Sum of Squared Difference (SSD) calculation, energy-function based calculation (e.g., by using Markov Random Field model), or other suitable methods.

FIG. 10 is a schematic diagram illustrating a system 100a in accordance with embodiments of the disclosed technology. The system 100a includes multiple image collection devices 104a-n, a server 105, and a user device 108. The image collection devices 104a-n, the server 105, and the user device 108 can communicate with one another via a network 107. The system enables a user 15 to view a three-dimensional live stream generated by the server 105. The server 105 generates the three-dimensional live stream based on live streams collected by the image collection devices 104a-n.

The locations of the image collection devices 104a-n are known (e.g., FIG. 3) or could be measured (e.g., FIG. 4), and the server 105 can accordingly combine two or more live streams collected by the image collection devices 104a-n to generate the three-dimensional live stream (e.g., based on the distance between two of the image collection devices 104a-n and corresponding view differences discussed above with reference to FIG. 1B).

In some embodiments, the server 105 can be implemented as an image server that can receive images from the image collection devices 104a-n. In some embodiments, the image collection devices 104a-n can include a portable camera, a mobile device with a camera lens module, a fixed camera, etc.

As shown, the server 105 includes a processor 109, a memory 111, an image database 113, an image management component 115, a communication component 117, and an account management component 119. The processor 109 is configured to control the memory 111 and other components (e.g., components 113-119) in the server 105. The memory 111 is coupled to the processor 109 and configured to store instructions for controlling other components or other information in the system 100a.

The image database 113 is configured to store, temporarily or permanently, image files (e.g., live broadcasting videos, live streams, etc.) from the image collection devices 104. In some embodiments, the image database 113 can have a distributed structure such that it can include multiple physical/virtual partitions across the network 107. In some embodiments, the image database 113 can be a hard disk drive or other suitable storage means.

The communication component 117 is configured to communicate with other devices (e.g., the user device 108 or the image collection devices 104) and other servers (e.g., social network server, other image servers, etc.) via the network 107. In some embodiments, the communication component 117 can be an integrated chip/module/component that is capable of communicating with multiple devices.

The image management component 115 is configured to analyze, manage, and/or edit the received image files. For example, the image management component 115 can analyze image information (e.g., image quality, duration, time of creation, location of creation, created by which device, uploaded to which image server, authenticated by which social media, etc.) associated with the received image files and then synchronize the images files (e.g., to adjust a time stamp of each image files such that these image files can be referenced by a unified timeline). The time stamps can be used for pairing two images from two cameras during live broadcasting. For example, if a time between the two images is smaller than a threshold, then the two images can be paired. The paired images can then be live streamed together.

In some embodiments, the system may adopt following methods to synchronize the time. The system can apply a server time setting to all associated cameras. For example, the server can transmit a server time setting to all cameras and replace the cameras' own time settings. Alternatively, the system can select a master camera and then transmit a time setting of the master camera to all other cameras. The time setting of these cameras can be replaced by the time setting of the master camera. In some embodiments, communications between cameras can be via a local connection (e.g., a Bluetooth connection, a WLAN connection, etc.). The system can also synchronize time setting of each camera based on a reference used in a GPS system or other similar networks that can provide a unified, standard time setting.

The image management component 115 is also configured to combine the synchronized image files to form one or more three-dimensional live streams. For example, the image management component 115 can combine live stream images from two or more image collection devices 104 based on the distance therebetween and corresponding view differences (discussed in detail above with reference to FIG. 1B). The three-dimensional live streams generated by the image management component 115 can be stored in the image database 113 for further use (e.g., to be transmitted to the user device 108 for the user 15 to view).

For example, when the user 15 wants to view the three-dimensional live streams via the user device 108, the user 15 can input, via an input device 121 of the user device 108, one or more criteria (e.g., image sources, time periods, image quality, angles of view, numbers of downloads, continuity thereof, content thereof, etc.) characterizing the three-dimensional live streams to be displayed. The criteria are then transmitted to the server 105 via the communication components 117, 117a via the network 107. Once the server 105 receives the criteria, the image management component 115 then identifies one or more three-dimensional live streams to be displayed and then transmit (e.g., live stream) the same to the user device 108.

In some embodiments, the image management component 115 can check/analyze the image quality (e.g., continuity) or a data transmission rate for the image files that are streaming of the identified images files before transmitting to the user device 108. In some embodiments, if the identified images do not meet a predetermined threshold, the image management component 115 can (1) decide not to display the identified images; (2) display the identified images after receiving a user's confirmation; or (3) adjust the dimension/location of the displaying areas and display the identified images (e.g., reduce the size thereof or move the displaying areas). In some embodiments, the image management component 115 can adjust or edit the image files according to the criteria (e.g., adding background, filtering, adjusting the sizes thereof, combining two of more image files, etc.).

In some embodiments, the image management component 115 can process the image files based on user preferences managed by an account management component 119. The account management component 119 is configured to manage multiple viewers' configurations, preferences, prior viewing habits/histories, and/or other suitable settings. Such information can be used to determine which image files to be identified and how to process the identified image files before transmitting them to the user device 108 to be visually presented to the user 15 by a display 125.

As shown in FIG. 10, the user device 108 includes a processor 109a, a memory 111a, and a communication component 117a, which can perform functions similar to those of the processor 109, the memory 111, and the communication component 117, respectively.

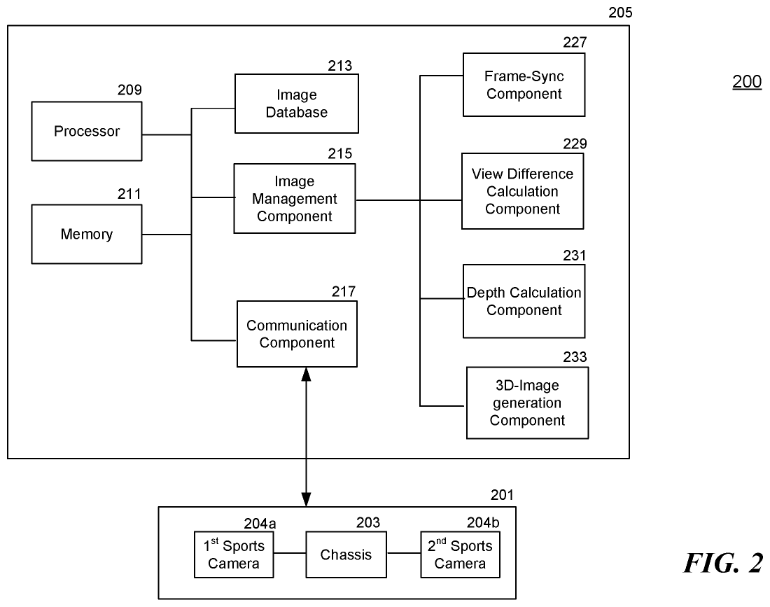

FIG. 2 is a schematic diagram illustrating a system 200 in accordance with embodiments of the disclosed technology. The system 200 includes a server 205 and a live-stream device 201. The live streaming device 201 is configured to collect images and then transmit or upload the same to the server 205 for further processing. The live streaming device 201 includes a first sports camera 204a, a second sports camera 204b, and a chassis 203 configured to couple/position the first/second sports cameras 204a, 204b. The first/second sports cameras 204a, 204b are configured to collect images of a target object and then transmit the collected images to the server 205. The server 205 is configured to analyze, edit, process, and/or store the uploaded images and then generate three-dimensional live streams for a user to view.

In the illustrated embodiments, the server 205 includes a processor 209, a memory 211, an image database 213, an image management component 215, a communication component 217, and an account management component 219. The processor 209, the memory 211, the image database 213, the communication component 217, and the account management component 219 respectively perform functions similar to those of the processor 109, the memory 111, the image database 113, and the communication component 117 discussed above.

As shown, the image management component 215 includes four sub-components, namely a frame-sync component 227, a view difference calculation component 229, a depth calculation component 231, and a 3D-image generation component 233. The frame-sync component 227 is configured to synchronize the live streams or images transmitted from the live-stream device 201 (e.g., to adjust the time label of each live stream such that the live streams can be referenced by a unified timeline). The view difference calculation component 229 is configured to calculate view difference (e.g., for each pixel point of the target object) between two sets of images or live streams from the first/second sports cameras 204a, 204b. The determined view differences can then be transmitted to the depth calculation component 231 for further processing.

The depth calculation component 231 is configured to determine depth information of images for the target object (e.g., the “z” value discussed above with reference to FIG. 1B). Based on the methods discussed above with reference to FIG. 1B, the depth calculation component 231 determines the depth information for all the collected images or live streams (e.g. for each pixel thereof). Once the depth information is determined, the 3D-image generation component 233 can generate three-dimensional live streams based on the collected images and the corresponding depth information. For example, the 3D-image generation component 233 can combine or overlap two sets of images based on their respective depth values to form an image that provides three-dimensional visual experiences to a user (e.g., a 3D object shown in a 2D image, an object in a 3D movie, a 3D object in a virtual reality environment, etc.).

FIG. 3 is a schematic diagram illustrating a live-stream device 300 in accordance with embodiments of the disclosed technology. The live-stream device 300 includes a first camera 301, a second camera 302, and a chassis 303. The first and second cameras 301, 302 are capable of communicating with each other (or with other devices such as a server) via a wireless (or wired) communication. The chassis 303 is configured to couple the first camera 301 to the second camera 302. The chassis 303 includes a first connector 306a and a second connector 306b. The distance between the first and second connector 306a, 306b is distance D₁. The first camera 301 has a first recess 308a configured to accommodate the first connector 306a. The second camera 302 has a second recess 308b configured to accommodate the second connector 306b.

In the illustrated embodiment, the chassis 303 includes a first magnet 310a positioned adjacent to the first connector 306a. The first camera 301 includes a first sensor 312a (e.g., a magnetic field sensor such as a Hall-effect sensor) positioned adjacent to the first recess 308a. When the first connector 306a is positioned or inserted in the first recess 308a, the first sensor 312a senses the existence of the first magnet 310a and accordingly generates a first signal indicating that the first camera 301 is coupled to the chassis 303.

Similarly, the chassis 303 includes a second magnet 310b positioned adjacent to the second connector 306b. The second camera 302 includes a second sensor 312b positioned adjacent to the second recess 308b. When the second connector 306a is positioned or inserted in the second recess 308a, the second sensor 312b senses the existence of the second magnet 310b and accordingly generates a second signal indicating that the second camera 301 is coupled to the chassis 303.

In some embodiments, the first camera 301 can transmit the first signal to the second camera 302. When the second camera 302 receives the first signal from the first camera 301 and the second signal from the second sensor 312b, the second camera 302 can generate a confirmation signal (that the first and second cameras 301, 302 are positioned and spaced apart with distance D₁) and transmit the same to a server. In some embodiments, the confirmation signal can be generated and transmitted by the first camera 301 in a similar fashion.

When the server receives the confirmation signal, the server can confirm that the first and second cameras 301, 302 are in position and accordingly can further process images therefrom based on distance D₁. In some embodiments, distance D1 can be predetermined and is stored in the server or in at least one of the first and second cameras 301, 302.

In some embodiments, the first sensor 312a can be positioned in the chassis 303 and the first magnet 310a can be positioned in the first camera 301. In such embodiments, the first sensor 312a can transmit the first signal to the first camera 301 via a wireless communication. Similarly, in some embodiments, the second sensor 312b can be positioned in the chassis 303 and the second magnet 310b can be positioned in the second camera 302. In such embodiments, the second sensor 312b can transmit the second signal to the second camera 302 via a wireless communication.

In some embodiments, the first and second connectors 306a, 306b can be positioned in the first and second recesses 308a, 308b by various mechanical components such as a screw/bolt set, latches, hooks, and/or other suitable connecting components.

FIG. 4 is a schematic diagram illustrating a live-stream device 400 in accordance with embodiments of the disclosed technology. The live-stream device 400 includes a first camera 401, a second camera 402, and a chassis 403. The first and second cameras 401, 402 are capable of communicating with each other (or with other device such as a server) via a wireless (or wired) communication. The chassis 403 is configured to couple the first camera 401 to the second camera 402. The chassis 403 includes a first connector 406a, a second connector 406b, an electrical resistance sensor 414, and a sliding rail 416. The first connector 406a and the second connector 406b are slidably positioned on two ends of the sliding rail 416. The electrical resistance sensor 414 is configured to measure the electrical resistance of a rail portion 418 that is between the first connector 406a and the second connector 406b. In some embodiments, the electrical resistance sensor 414 can transmit the measured electrical resistance to the first camera 401 or to the second camera 402, and then a processor therein can determine or calculate a distance D2 between the two cameras 401, 402 based on the measured electrical resistance. In some embodiments, the electrical resistance sensor 414 can be coupled to a processor, a chip, or a logic unit of the chassis 403 that can determine/calculate distance D₂ based on the measured electrical resistance. The determined distance D₂ can then be transmitted to one of the two cameras 401, 402 and then to a server.

As shown, the first camera 401 has a first recess 408a configured to accommodate the first connector 406a. There is a first contacting point 420a positioned on the surface of the first recess 408a. The first connector 406a includes a first tip 422a configured to electrically couple to the first contacting point 420a. When the first connector 406a is positioned or inserted in the first recess 408a, the first tip 422a is in contact with the first contacting point 420a. The first camera 401 detects the contact (e.g., by a sensor, not shown) and confirms that the first camera 401 is coupled to the chassis 403.

Similarly, the second camera 402 has a second recess 408b configured to accommodate the second connector 406b. There is a second contacting point 420b positioned on the surface of the second recess 408b. The second connector 406b includes a second tip 422b configured to electrically couple to the second contacting point 420b. When the second connector 406b is positioned or inserted in the second recess 408b, the second tip 422b is in contact with the second contacting point 420b. The second camera 402 detects the contact (e.g., by a sensor, not shown) and confirms that the second camera 402 is coupled to the chassis 403.

Once confirming that the first and second camera 401, 402 are coupled to the chassis 403, the electrical resistance of the rail portion 418 can be measured by the electrical resistance sensor 414 and accordingly distance D₂ can be determined. The determined distance D₂ can then be transmitted (e.g., by the first camera 401 or the second camera 402) to a server for further processing.

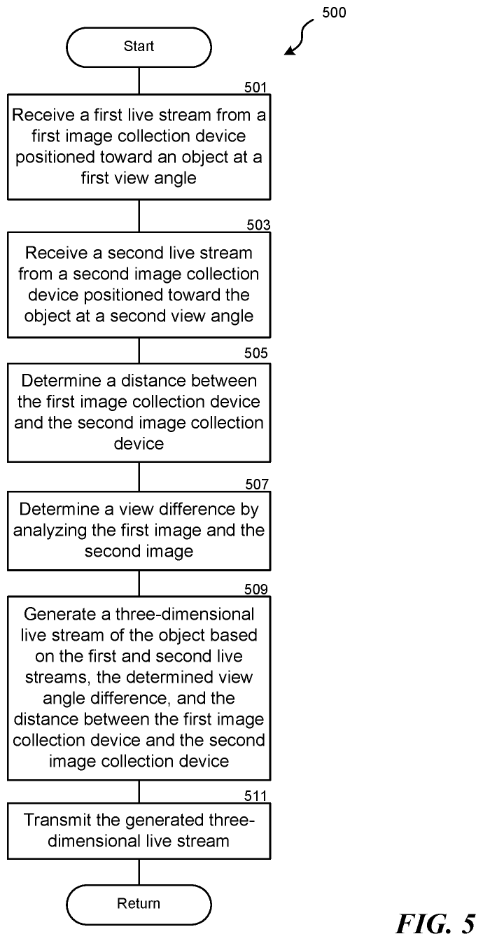

FIG. 5 is a flowchart illustrating a method 500 for live streaming a three-dimensional live stream based on two image collection devices (e.g., sports cameras) in accordance with embodiments of the disclosed technology. The method 500 can be implemented by a server (e.g., server 105 or 205), a computer, a user device, or other suitable devices. At block 501, the method 500 starts by receiving, e.g., at the server, a first live stream from a first image collection device positioned toward an object at a first view angle. By this arrangement, a first object image shown in the first image occupies a first percentage of area of the first image. In some embodiments, the first object image shown in the first image can be at a first location (e.g., the center) of the first image.

At block 503, the method 500 continues by receiving, e.g., at the server, a second live stream from a second image collection device positioned toward the object at a second view angle. When the second image collection device is operated at the second view angle, a second object image shown in the second image occupies a second percentage of area of the second image. The first percentage is generally the same as the second percentage. In some embodiments, the second object image shown in the second image can be at a second location (e.g., the center) of the second image, and the first location is generally the same as the second location. By this arrangement, the first and second image collection devices are positioned to collect images with the object therein and the collected images are pre-configured to be further processed.

At block 505, a distance between the first image collection device and the second image collection device is determined. In some embodiments, the distance is determined by confirming that the first and second cameras are coupled to a chassis (e.g., as described in the embodiments with reference to FIGS. 3 and 4). At block 507, the method 500 continues by determining a view difference by analyzing the first image and the second image (e.g., discussed above with reference to FIG. 1B).

At block 509, a three-dimensional live stream of the object is generated based on the first and second live streams, the determined view difference, and the distance between the first image collection device and the second image collection device. At block 511, the method 500 enables the generated three-dimensional stream to be transmitted to a user device. The method 500 then returns for further process.

In some embodiments, the method 500 can include synchronizing the first image collection device and the second image collection before the first and second live streams are generated. In some embodiments, the method 500 can include synchronizing the first and second live streams.

In some embodiments, the distance between the first and second image collection devices is determined based on a pre-determined reference distance between first and second connectors of a chassis. The first and second connectors are configured to be positioned or inserted in the first and second image collection devices (e.g., FIG. 3). In some embodiments, the distance between the first and second image collection devices is determined based on a measurement of an electrical resistance (e.g., FIG. 4) between the first and second connectors.

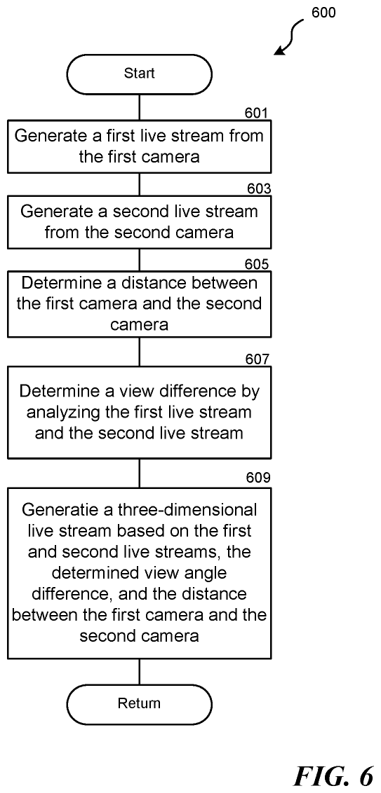

FIG. 6 is a flowchart illustrating a method 600 for live streaming based on a live-stream device (e.g., device 300 or 400). The live-stream device includes a first camera, a second camera, and a chassis coupled to the first and second cameras. The method 600 includes (1) generating a first live stream from the first camera (block 601); (2) generating a second live stream from the second camera (block 603); (3) determining a distance between the first camera and the second camera (block 605); (4) determining a view difference by analyzing the first live stream and the second live stream (block 607); and (5) generating a three-dimensional live stream based on the first and second live streams, the determined view difference, and the distance between the first camera and the second camera (block 609). The method 600 then returns for further process.

In the embodiments discussed herein, a “component” can include a processor, control logic, a digital signal processor, a computing unit, and/or other suitable devices.

Although the present technology has been described with reference to specific exemplary embodiments, it will be recognized that the present technology is not limited to the embodiments described but can be practiced with modification and alteration within the spirit and scope of the appended claims. Accordingly, the specification and drawings are to be regarded in an illustrative sense rather than a restrictive sense.

1. A method for live streaming a three-dimensional live stream based on two image collection devices, the method comprising:
receiving a first live stream from a first image collection device positioned toward an object at a first view angle such that a first object image shown in the first image occupies a first percentage of area of the first image;
receiving a second live stream from a second image collection device positioned toward the object at a second view angle such that a second object image shown in the second image occupies a second percentage of area of the second image, wherein the first percentage is generally the same as the second percentage;
determining a distance between the first image collection device and the second image collection device;
determining a view difference by analyzing pixels of the first live stream and the second live stream;
generating a three-dimensional live stream of the object based on the first and second live streams, the determined view difference, and the distance between the first image collection device and the second image collection device; and
transmitting the generated three-dimensional live stream.

2. The method of claim 1, further comprising:
transmitting an instruction to synchronize the first image collection device and the second image collection before the first and second live streams are generated.

3. The method of claim 1, further comprising:
pairing the received first and second live streams according to time stamps embedded in images of the received first and second live streams.

4. The method of claim 1, wherein the first image collection device and the second image collection device are coupled to a chassis.

5. The method of claim 4, wherein the chassis includes a first connector configured to couple to the first image collection device, and wherein the chassis includes a second connector configured to couple to the second image collection device, and wherein the first image collection device and the second image collection device derive the distance between the first and second image collection devices from the chassis.

6. The method of claim 5, wherein the distance between the first and second image collection devices is determined based on a reference distance between the first connector and the second connector.

7. The method of claim 5, wherein the chassis includes a first magnet positioned adjacent to the first connector, and wherein the chassis includes a second magnet positioned adjacent to the second connector.

8. The method of claim 7, wherein the first image collection device has a first recess configured to accommodate the first connector, and wherein the first image collection device includes a first Hall-effect sensor positioned adjacent to the first recess, and wherein the second image collection device has a second recess configured to accommodate the second connector, and wherein the second image collection device includes a second Hall-effect sensor positioned adjacent to the second recess.

9. The method of claim 8, further comprising:
determining that the first connector is positioned in the first recess when the first Hall-effect sensor detects the first magnet; and
determining that the second connector is positioned in the second recess when the second Hall-effect sensor detects the second magnet.

10. The method of claim 9, further comprising:
determining that the distance between the first image collection device and the second image collection device is a distance between the first connector and the second connector, when the first connector is determined being positioned in the first recess and when the second connector is determined being positioned in the second recess.

11. The method of claim 4, wherein the chassis includes a sliding rail, a first connector positioned on the sliding rail and a second connector positioned on the sliding rail.

12. The method of claim 11, wherein the chassis includes an electrical resistance detection component configured to measure an electrical resistance between the first connector and the second connector.

13. The method of claim 12, further comprising:
determining the distance between the first image collection device and the second image collection device based on the measured electrical resistance between the first connector and the second connector.

14. A system for live streaming a three-dimensional live stream, the system comprising:
a first image collection device positioned toward an object at a first view angle such that a first object image shown in the first image occupies a first percentage of area of the first image;
a second image collection device positioned toward the object at a second view angle such that a second object image shown in the second image occupies a second percentage of area of the second image, wherein the first percentage is generally the substantially as the second percentage; and
a server configured to—
receive a first live stream from the first image collection device;
receive a second live stream from the second image collection device;
receive a distance between the first image collection device and the second image collection device from the first image collection device or the second image collection device;
determine a view difference by analyzing pixels of the first live stream and the second live stream; and
generate, based on the first and second live streams, a three-dimensional live stream of the object according to the determined view difference and the distance between the first image collection device and the second image collection device.

15. The system of claim 14, further comprising:
a synchronization component configured to synchronize the received first and second live streams.

16. The system of claim 15, further comprising:
an view difference calculation component configured to pair images of the synchronized first and second live streams to generate the view difference.

17. The system of claim 16, further comprising:
a depth calculation component configured to determine a set of depth information based on the view difference and the distance between the first image collection device and the second image collection device.

18. The system of claim 17, further comprising:
a chassis structure configured to couple the first image collection device to the second image collection device.

19. A method for live streaming a three-dimensional live stream based on a live-stream device, the live streaming device including first and second cameras coupled by a chassis, the method comprising:
generating a first live stream from the first camera;
generating a second live stream from the second camera;
determining a distance between the first camera and the second camera;
determining a view difference by analyzing pixels of the first live stream and the second live stream; and
generating a three-dimensional live stream of the object based on the first and second live streams, the determined view difference, and the distance between the first camera and the second camera.

20. The method of claim 1, further comprising determining the distance between the first camera and the second camera based on a measured electrical resistance between the first camera and the second camera.
